(19) United States
(12) Patent Application Publication
(10) Pub. No.: US 2004/0167991 A1
(43) Pub. Date: Aug. 26, 2004

(54) Method for providing gated network access

(75) Inventors: Robert C. Stowe, Manchester, CT (US); Joseph P. Johnson, Worcester, MA (US); Leon E. Gagnon, North Scituate, RI (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: UPS, Inc.

(21) Appl. No.: 10/690,982

(22) Filed: Oct. 22, 2003

Related U.S. Application Data
(60) Provisional application No. 60/425,133, filed on Nov. 8, 2002.

(51) Int. Cl. G06F 17/60; G06F 15/16

(52) U.S. Cl. 709/248; 705/40

(57) ABSTRACT

The present invention is generally directed to methods for an entity to provide access to Internet websites associated with the entity to customers that currently do not have Internet access. Additional methods are provided for billing an entity associated with a website for access to the website by the entity's customers.

### CROSS REFERENCE TO RELATED APPLICATION

This application claims the benefit and priority of pending Provisional Application having Ser. No. 60/425,133, filed on Nov. 8, 2002, entitled “Gated Network Access Systems and Methods,” which is incorporated herein by reference.

### FIELD OF THE INVENTION

The present invention provides methods that allow a website owner to provide access to its website by users that do not otherwise have Internet access. Methods are described that allow an internet service provider (ISP) to charge a website owner or operator when a non-subscribed user accesses the website through the ISP network.

### BACKGROUND OF THE INVENTION

The rise of the Internet has resulted in an unprecedented increase in on-line commerce. In today's world, businesses often need an on-line presence to remain competitive. A U.S. Department of Commerce report recently indicated that second-quarter 2002 retail e-commerce sales were an estimated $10.243 billion, an increase of about 24 percent from the second quarter of 2001. The report, put out by the Census Bureau, stated that total retail sales for the period were an estimated $825.5 billion, an increase of about 2.5 percent from the prior year.

While the e-commerce explosion has been impressive, a limiting factor in e-commerce growth has been the number of businesses and persons that are not yet connected to the Internet. A Census Bureau report released in 2001 indicated that over 60 million U.S. households do not have a computer in the home with a connection to the Internet. Some of the individuals in these households may access the Internet from a computer at work, school or elsewhere, but the census data makes clear that the lack of Internet access prevents a significant portion of the population from participating in e-commerce. An unsatisfied need therefore exists for improved systems and methods that provide these customers and businesses with access to e-commerce resources.

A substantial hurdle in providing user access to an e-commerce resource such as a website of an electronic retailer is the subscription fee of an internet service provider (ISP). An ISP is an organization that provides access to the Internet. Small ISPs provide service via modem and ISDN while the larger ones also offer private line hookups (T1, fractional T1, etc.). ISPs use several methods to bill users for Internet access. A popular fee arrangement is to bill users a subscription fee that provides them with unlimited Internet access at a fixed monthly rate. Another billing method used by ISPs is to charge the user an hourly rate for the amount of time spent on-line. Alternatively, ISPs employ a hybrid billing system that gives users a limited number of hours of Internet access for a relatively small fixed fee, with excess charges applied if users exceed the limit.

In each of these billing processes, the ISP charges the user for the right to connect to the Internet. Common sense would seem to indicate that website owners and operators benefit from having a greater number of users Internet-enabled, and hence equipped to reach their websites, but the ISP billing systems that are known in the art provide no mechanism by which a website owner can facilitate a user's access to the Internet. An unsatisfied need therefore exists for improved systems and methods that allow a third party, such as an owner or operator of a website, to facilitate a user's access to the Internet.

In addition, an entity may seek to facilitate access to websites they are associated with, but they do not want to facilitate access to their competitors' sites. There are techniques known in the art for restricting general access to the Internet; however, no mechanisms are provided for a website owner to control general Internet access of a user. The known systems are generally directed at restricting access by children to violent or pornographic websites, or at restricting employee's access to non-business related websites. Techniques used to accomplish these tasks include rating systems, key word searches, domain name filters, etc. The typical system monitors the content of either the request made by the user or the response by the website for key terms that are stored in a database. If a key word is found, such as “sex,” the connection with the website is blocked. Filtering or blocking software can be provided on the user's computer, or an ISP can supply a filtering service. Generally, the databases containing the key terms are modified or amended by a parent or supervisor desiring to restrict a user's Internet access.

U.S. Pat. No. 5,696,898 to Baker et al. describes a system for granting access to approved websites based on a relational database. When a user attempts to access a website, the URL is checked against the database for approved sites, and if the site is not present, access is denied. A resident authority at the user's location controls the approved website list, and the database is stored on a proxy server on the user's local network.

U.S. Pat. No. 5,884,033 to Duvall et al. describes a filtering system that monitors the content of incoming and outgoing messages against a filtering database. If a match is found, the information is blocked. The items filtered include incoming messages, IP addresses, domain names, and phrases within the domain name. The filtering mechanism is located either on the user's computer or the user's network server. The filtering database may be modified as necessary by an authorized user.

U.S. Pat. No. 5,889,958 to Willens describes an Internet access control system, which restricts a user's Internet access to approved sites. A filter compares a requested website domain name to a database of approved sites and allows access to only the sites on the list. The filters can be customized to the user or computer. When a user signs onto the system, an associated filter is applied. The filters are stored on a central server at client's location or at the ISP. An additional aspect of patent describes using the filtering mechanism to grant access to non-public portions of a website with a password. The website owner has no control over the access of the user to other websites.

In each of the references cited above, the user's Internet access is controlled by someone associated with the user. These systems can be valuable for blocking a child from accessing a site with adult content, or an organization blocking an employee from accessing a non-business site; however, there is no mechanism by which an entity associated with a website can control the general Internet access of a user. Moreover, none of the foregoing patents teach or suggest a process through which a website owner can provide Internet access to a customer that does not have Internet access.

An unsatisfied need exists in the industry for improved system and methods to allow an entity associated with a website to facilitate access to the Internet by a customer.

### SUMMARY OF THE INVENTION

The present invention provides methods that allow a website owner to provide access to its website by users that do not otherwise have Internet access. An additional aspect of the invention provides methods that allow an internet service provider (ISP) to charge a website owner or operator when a non-subscribed user accesses the website through the ISP network. A further aspect provides methods for a carrier to provide shipping labels to a shipper via the Internet, wherein the shippers do not otherwise have Internet access.

In accordance with an embodiment of the present invention, a method of allowing a carrier to provide shipping services to a user via one or more Internet websites associated with the carrier is described, wherein the user does not have access to the Internet. The method includes the steps of: providing the user with a network terminal that is configured to access the Internet via a link between the network terminal and an internet service provider; establishing a billing relationship with the internet service provider such that the internet service provider monitors the Internet access by the network terminal and charges the carrier for the access; and restricting the access of the network terminal to the one or more Internet websites associated with the carrier. In an alternative embodiment, the communication link is by wireless transmission. In further embodiments, the step of restricting access of the network terminal is performed by the internet service provider or the network terminal. In alternative embodiments of the present invention, the monitoring of Internet access by the internet service provider includes monitoring the quantity of hits from the network terminal on the one or more Internet websites, monitoring the duration of access of the network terminal to the one or more Internet websites, or monitoring the quantity of data transferred between the network terminal and the one or more Internet websites.

In accordance with an embodiment of the present invention, a method of billing for providing access to a one or more IP addresses associated with an entity is described. This embodiment includes the steps of: establishing a communication link between a network terminal and the Internet; restricting access of the network terminal to one or more IP addresses on the Internet, where one or more addresses is predetermined by an entity, and wherein the entity is associated with the one or more IP addresses; monitoring the access by the terminal to the one or more IP addresses; and billing the entity a fee based upon the access. The step of monitoring access by the network terminal may include monitoring the quantity of hits from the network terminal on the one or more IP addresses, monitoring the duration of access of the network terminal to the one or more IP addresses, or monitoring the quantity of data transferred by between the network terminal and the one or more IP addresses. In an alternative embodiment, the communication link is by wireless transmission.

In accordance with an embodiment of the present invention, a method of allowing a carrier to provide a shipping label to a shipper via an Internet website associated with the carrier is described, wherein the shipper does not have access to the Internet. The method includes the steps of: providing the shipper with a network terminal that is configured to access the Internet via a link between the network terminal and an internet service provider, and the network terminal is further configured to generate the shipping label based on communication with the Internet website; establishing a billing relationship with the internet service provider such that the internet service provider monitors the Internet access by the network terminal and charges the carrier for the access; and restricting the access of the network terminal to the one or more Internet websites associated with the carrier. An alternative embodiment includes providing a printing device configured to communicate with the network terminal and print the shipping label. A further embodiment provides a communication link by wireless transmission. In alternative embodiments of the invention, the monitoring of Internet access is by monitoring the quantity of hits from the network terminal on the one or more Internet websites, monitoring the duration of access of the network terminal to the one or more Internet websites, or monitoring the quantity of data transferred between the network terminal and the one or more Internet websites. In a further embodiment, the internet service provider or the network terminal restricts the Internet access.

### BRIEF DESCRIPTION OF THE DRAWINGS

Having thus described the invention in general terms, reference will now be made to the accompanying drawings, which are not necessarily drawn to scale and wherein:

FIG. 1 is a block diagram depicting an embodiment of the present invention.

FIG. 2 is a block diagram depicting the components of a network terminal of an embodiment of the present invention.

FIG. 3 is a process flow diagram that illustrates the steps in creating a shipping label via the Internet.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

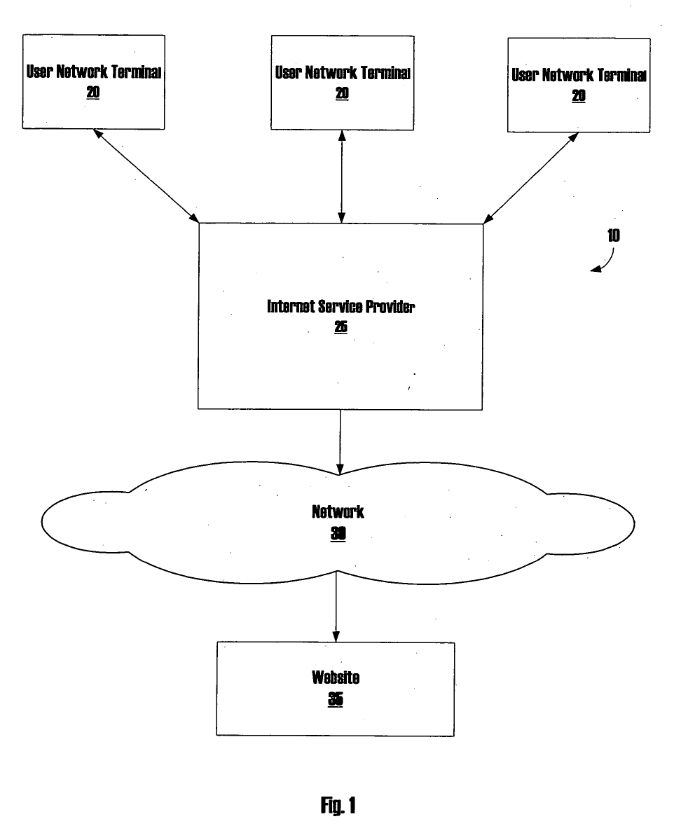

FIG. 1 is a high-level block diagram of a gated network access system 10 in accordance with an embodiment of the present invention. In this embodiment, a user connects to a website 35 through a network terminal 20, ISP 25, and network 30. While the network 30 is referenced herein as the Internet, one of ordinary skill in the art will readily recognize that the systems and methods of the invention are equally advantageous in any networked environment.

The gated network access system 10 provides communication between the network terminal 20 and a target computer connected to the network 30 at a unique network address. The steps of establishing a communication between two computers via a network are well known in the art. As one of ordinary skill knows, the Internet is a worldwide network of computers that communicate with one another via transmission control protocol/Internet protocol (TCP/IP). TCP/IP is a routable protocol, which allows any electronic message to contain not only the address of the destination station, but also the address of a destination network. As a result, TCP/IP messages can be sent to multiple networks within an organization or around the world, hence its use in the worldwide Internet.

All computers that are connected to the Internet have an IP address that consists of four numbers separated by periods (for example: 123.4567.89.1011). To make addresses easier for humans to remember, domain name services (DNS) associate domain names like www.ups.com with the numeric address of the computer where that domain is hosted. When a user enters a domain name into his or her computer, the computer transmits a request for a file from the address associated with that domain name. In the case of the World Wide Web, the file requested is a web page document that is transmitted from a target computer to the user's computer where it is displayed on a software application known as a browser.

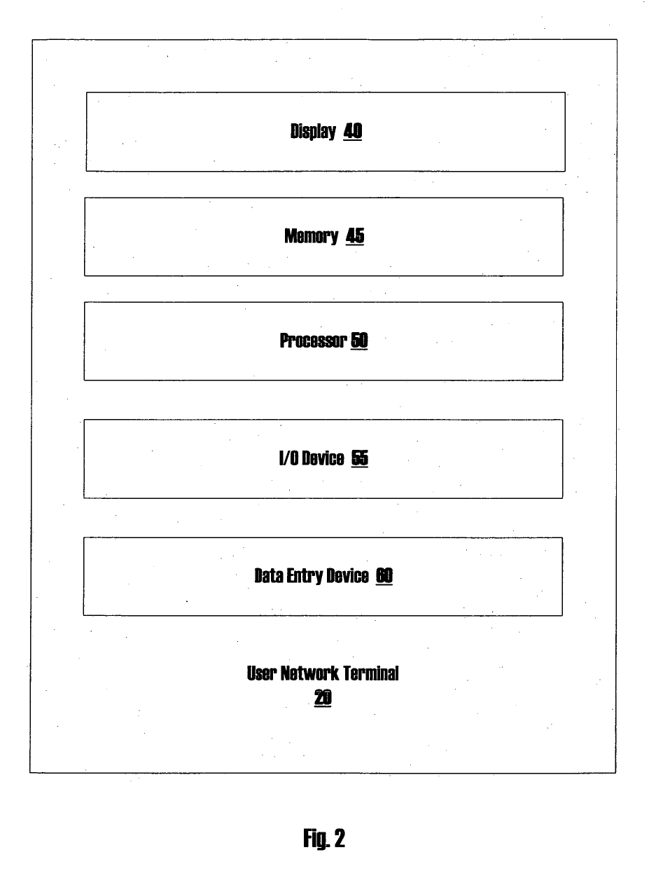

In the embodiment shown in FIG. 1, the network terminal 20 assumes the role of the user computer in that it allows a user to establish communication with a target computer via the network 30. FIG. 2 illustrates the components that comprise an embodiment of a network terminal 20; these include a display 40, memory 45, processor 50, an input/output interface 55 and a data entry device 60. The components of the network terminal 20 work in the same manner as they would in a personal computer and, as such, their operation is well known in the art.

In a preferred embodiment, the network terminal 20 runs on a Linux operating system. One of ordinary skill in the art will readily recognize that other operating systems are known in the art and may be used with the network terminal 20. Linux is a popular option for network communication due to its stability and the fact that it is open source software that is freely available. Another software application that runs on the network terminal 20 is a web browser such as that produced by Espial. Web browsers are well known in the art and serve as the front end to the World Wide Web on the Internet. One of ordinary skill will readily recognize that a variety of web browsers are available and may be used with the present invention. In addition, certain web pages may be optimized for one or more particular browsers and the network terminal 20 may give the user the option of choosing between multiple web browsers.

The foregoing description of the network terminal 20 is not intended to be exhaustive. One of ordinary skill will readily recognize that the functionality and performance of the network terminal 20 can be readily enhanced with the addition of other hardware and/or software. In a preferred embodiment, the network terminal 20 functions as an inexpensive Internet appliance that provides user access to a network 30. Accordingly, greater functionality and performance is sacrificed for cost savings and ease of use. In an embodiment in which the sole purpose of the gated network access system 10 is to provide user access to a network, the network terminal 20 may comprise only that hardware and software that is required to connect to the network and run a web browser application. In alternative embodiments where greater functionality is required, the user network terminal 20 can be modified to include additional hardware and/or software as necessary.

Returning again to FIG. 1, an ISP 25 handles the interface between the network terminal 20 and the network 30. ISPs are well known in the art and provide a variety of services that include Internet access, e-mail, website hosting, local content provision, firewalls and virtual private networks. To implement these services, an ISP uses a combination of servers, routers and switches as is well known in the art.

In the present invention, the I/O interface 55 of the network terminal 20 handles the communication with the ISP 25. In a preferred embodiment, the I/O interface 55 uses wireless transmission to communicate with the ISP 25. The benefit of wireless transmission is that the user does not require a telephone line or cable connection to access the network. Of course, in alternative embodiments, the communication between the network terminal 20 and the ISP 25 may occur via other transmission means known in the art including without limitation a telephone modem, cable modem, digital subscriber line (DSL), satellite, integrated services digital network (ISDN) or via a dedicated line.

An ISP 25 traditionally provides its subscribing users with complete or nearly complete access to World Wide Websites on the Internet. In contrast to this traditional Internet access arrangement, the gated network access system 10 of the present invention expressly restricts the user's network access to predetermined IP addresses. In a preferred embodiment, the web browser of the network terminal 20 is configured using gating techniques that are known in the art to restrict user Internet access. In one embodiment, the web browser restricts the user to a single IP address predetermined by an entity associated with the website at that location. In an alternative embodiment, the web browser restricts the user to a single domain. And in still another embodiment, the web browser is configured to restrict the user to a list of IP addresses. Other methods of restricting users to particular IP addresses are known in the art and one of ordinary skill will recognize that other methods and systems for restricting access may be used in the present invention. In an alternative embodiment, for example, the ISP 25 assumes the responsibility for limiting the user's access to IP addresses predetermined by an entity associated with the websites. A potential benefit of this alternative embodiment is that it separates the user from the system component that is performing the restriction, which decreases the likelihood that a user will circumvent the restriction. One of ordinary skill in the art will readily recognize that other methods exist to limit Internet access and that these methods can be used in the present invention.

In one aspect of the present invention, a method is provided whereby a gated network access system is used to provide Internet access to a user. In a preferred method of the invention, an entity seeking to increase the utilization of a website associated with the entity, provides current or potential users of the website with a network terminal 20. The network terminal 20 is configured to only access websites 35 predetermined by the entity. The network terminal is preferably offered to the user for free or at a discount.

Once the network terminal is installed at the user's location, a communication link is established between the network terminal and the Internet using an ISP. The communication is preferably by wireless transmission because it promotes easy installation and operation at the user's location. However, other transmission means known in the art may be used including a telephone modem, cable modem, digital subscriber line (DSL), satellite, integrated services digital network (ISDN) or via a dedicated line.

In a preferred embodiment of the invention, the entity provides both the network terminal and the ISP service at no cost to the user. The entity may enter into a billing arrangement with one or more ISPs to provide access to the entity's associated websites via the Internet at no charge to the user. Instead, the ISPs charge the entity for the user's access. An ISP will agree to this type of billing arrangement because the ISP gains the revenue generated by the users' access to the IP addresses allowed by the gated access system 10. Moreover, because the users' Internet access through the gated access system 10 is restricted to a subset of IP addresses, the limited Internet access alternative does not interfere with the ISP's traditional efforts to market access to the unrestricted Internet to the same users.

In an alternate embodiment, the network terminal is configured to access virtually the entire World Wide Web; however, the ISP restricts Internet access of the network terminal to IP addresses predetermined by the entity. The predetermined IP addresses correspond to websites associated with an entity. In this embodiment, the gating function is performed by the ISP instead of the network terminal. As will be recognized by those of ordinary skill in the art, an ISP can implement filtering and blocking techniques in their proxy servers or routers to accomplish the limited access function.

An additional aspect of the invention provides methods by which an ISP can bill an entity for providing a network terminal access to predetermined IP addresses. Techniques are known in the art that allow an ISP to measure the data uploaded and downloaded from a particular user. Cisco markets a data-measuring device called Netflow™ which can be implemented within Cisco's routers and switches. As is well known in the art, software is available to analyze the data gathered by this device. Preferably, software offered by the Cooperative Association for Internet Data Analysis (CAIDA) called cflowd™ is used to analyze the Netflow™ data. Alternate techniques exist that monitor the transfer of data directly at the host. One of ordinary skill in the art will recognize that any technique which gathers traffic flow data for an IP address may be used in the present invention. Accordingly, the ISP may elect to charge an entity an amount based on the data uploaded or downloaded from a gated network access system 10. Alternatively, access charges may be based on the length of the connection and/or the number of website “hits” from the network terminal 20. One of ordinary skill will readily recognize that hybrid billing systems can also be designed for use with the present invention.

The following paragraphs describe how an entity such as United Parcel Services of America, Inc. (UPS) can use the present invention to service a segment of its customer base. UPS offers a variety of services and on-line applications to its customers through its website, www.ups.com. These services include generating shipping labels, estimating delivery time, tracking packages, etc. The ability to generate a shipping label on a web browser and print the label on an attached printer helps to automate the shipping process for the customer. The on-line tracking application provides customers with an efficient method of monitoring the delivery of their packages through the UPS delivery network. UPS, in turn, benefits because the customer uses UPS to ship the package and the shipping applications allow UPS to electronically capture the shipping information from the customer.

UPS tracking and shipping applications, however, are only available to UPS customers who have a computer with an Internet connection that gives them access to the UPS website. At present, a significant portion of the UPS client base cannot access the UPS website, either because the customer has no computer with Internet access, or because the customer refuses to provide Internet access to the systems the customer uses to track and ship packages. For example, a business may use UPS to ship packages but may not have an Internet-connected computer on the loading docks where the shipping occurs. Alternatively, the business may use a computer for shipping packages, but may not have a spare phone line readily available for Internet access.

The gated network access system 10 of the present invention provides a novel solution to this problem. For example, UPS can offer those customers that do not have Internet access a user network terminal 20 configured to access only the IP address associated with the UPS website. These terminals may be offered for free with the assumption that UPS will recoup the cost of the terminal in its package delivery service, or the terminals may be mass-produced and offered by UPS to its customers at a discount. In either case, the customer benefits by receiving a Internet-enabled shipping system for free or at a discounted price, and UPS benefits in that the customer will use UPS to service its shipping needs and will take advantage of the shipping applications provided on the website.

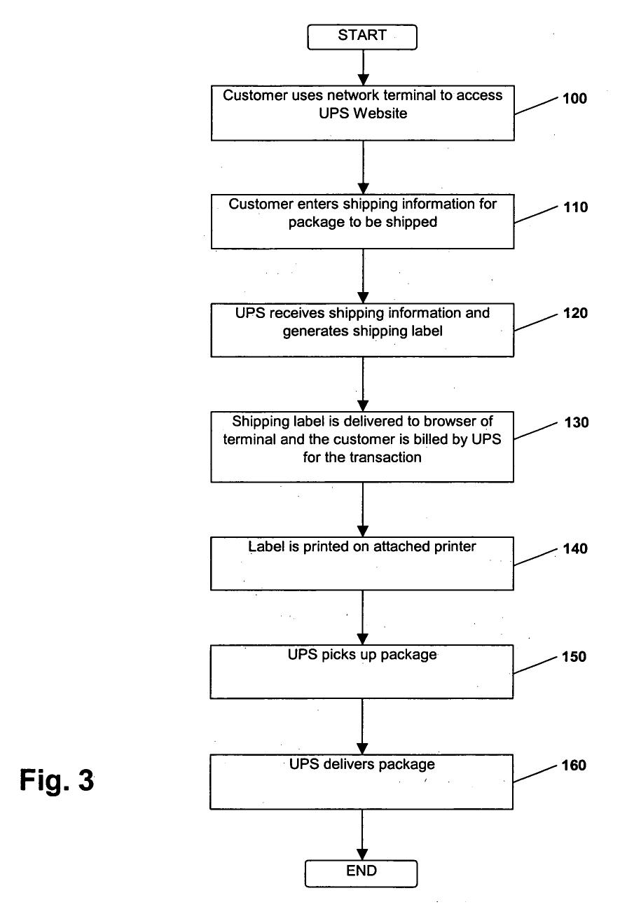

FIG. 3 depicts a flowchart illustrating how UPS may use the inventive method of the present invention to allow a customer to obtain a shipping label through the Internet. This process begins with the customer using a network terminal to access the UPS package delivery website, at step 100. The customer then enters the shipping information for the package to be shipped into the system at Step 110. This information contains the pick up address, destination address and the level of service desired. At Step 120, UPS receives the information and generates a shipping label. The shipping label information is transmitted back to the browser of the customer's network terminal at Step 130, and at the same time, UPS bills the customer for the transaction.

After the label information is received by the customer's network terminal at Step 130, the customer prints the label on an attached printer and affixes the label to the package at Step 140. At Step 150, a UPS employee picks the package up from the customer at Step 150 and delivers the package to the specified destination at Step 160.

The gated network access system 10, which comprises an ordered listing of selectable services can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (magnetic), a read-only memory (ROM) (magnetic), an erasable programmable read-only memory (EPROM or Flash memory) (magnetic), an optical fiber (optical), and a portable compact disc read-only memory (CDROM) (optical). Note that the computer-readable medium could even be paper or another suitable medium, upon which the program is printed, as the program can be electronically captured, via for instance optical scanning of the paper or other medium, then compiled, interpreted or otherwise processed in a suitable manner if necessary, and then stored in a computer memory.

Further, any process descriptions or blocks in flow charts should be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

Although the foregoing invention description uses a UPS business model as an example, it will be readily apparent that the present invention can be used by any entity to provide limited network access to otherwise disconnected users. Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of allowing a carrier to provide shipping services to a user via one or more Internet websites associated with said carrier, wherein said user does not have access to the Internet, said method comprising:
providing said user with a network terminal that is configured to access the Internet via a link between said network terminal and an internet service provider;
establishing a billing relationship with said internet service provider such that said internet service provider monitors said Internet access by said network terminal and charges said carrier for said access; and
restricting said access of said network terminal to said one or more Internet websites associated with said carrier.

2. The method of providing access of claim 1, wherein said communication link is by wireless transmission.

3. The method of providing access of claim 1, wherein said step of restricting access is performed by said network terminal.

4. The method of providing access of claim 1, wherein said step of restricting access is performed by said internet service provider.

5. The method of providing access of claim 1, wherein said monitoring of said Internet access comprises monitoring quantity of hits from said network terminal on said one or more Internet websites.

6. The method of providing access of claim 1, wherein said monitoring of said Internet access comprises monitoring duration of access of said network terminal to said one or more Internet websites.

7. The method of providing access of claim 1, wherein said monitoring of said Internet access comprises monitoring quantity of data transferred between said network terminal and said one or more Internet websites.

8. A method of billing for providing access to a one or more IP addresses associated with an entity, said method comprising the steps of:
establishing a communication link between a network terminal and the Internet;
restricting access of said network terminal to a one or more IP addresses on the Internet, said one or more addresses predetermine by an entity, wherein said entity is associated with said one or more IP addresses;
monitoring said access by said network terminal to said one or more IP addresses; and
billing said entity a fee based upon said access.

9. The method of billing of claim 8, wherein said step of monitoring said access comprises monitoring quantity of hits from said network terminal on said one or more IP addresses.

10. The method of billing of claim 8, wherein said step of monitoring said access comprises monitoring duration of access of said network terminal to said one or more IP addresses.

11. The method of billing of claim 8, wherein said step of monitoring said access comprises monitoring quantity of data transferred between said network terminal and said one or more IP addresses.

12. The method of billing of claim 8, wherein said subset of network addresses comprises a single IP addresses.

13. The method of billing of claim 8, wherein said communication link is by wireless transmission.

14. A method of providing a shipper that does not have access to the Internet with access to a carrier website, said method comprising:
providing said shipper with a carrier-supplied terminal that is configured to access said Internet via a link between said terminal and an internet service provider;
establishing a billing relationship with said internet service provider such that carrier pays for any Internet access by said terminal; and
restricting said Internet access to said carrier website.

15. The method of claim 14, further comprising the step of providing said shipper with access to a shipping tool on said carrier website that generates a shipping label and delivers said shipping label to a browser associated with said terminal.

16. The method of claim 14, wherein said communication link is by wireless transmission.

17. The method of claim 14, wherein said step of restricting access comprises said monitoring said Internet access at said service provider and refusing any access by said terminal except access to said carrier website.

18. The method of claim 14, wherein said step of establishing a billing relationship comprises establishing an Internet service provider to provide said link between said terminal and said Internet; monitoring said Internet access at said Internet service provider; and billing said carrier based at least in part on said Internet access that is detected by said monitoring.

19. The method claim 18, wherein said monitoring of said Internet access comprises monitoring a duration of access of said terminal to said carrier website.

20. The method claim 18, wherein said monitoring of said Internet access comprises monitoring a quantity of hits by said terminal at said carrier website.

21. The method of claim 18, wherein said monitoring of said Internet access comprises monitoring a quantity of data transferred between said terminal and said carrier website.
